(19) United States
(12) Patent Application Publication
(10) Pub. No.: US 2011/0145299 A1
(43) Pub. Date: Jun. 16, 2011

(54) Offline Gadgets IDE

(75) Inventor: Xin Zhou, Beijing (CN)

(73) Assignee: Google Inc., Mountain View, CA (US)

(21) Appl. No.: 12/756,403

(22) Filed: Apr. 8, 2010

(30) Foreign Application Priority Data
Dec. 11, 2009 (CN) 200910259111.3

(51) Int. Cl. G06F 17/00; G06F 15/16; G06F 17/30

(52) U.S. Cl. 707/802; 715/234; 709/203; 707/E17.044

(57) ABSTRACT

The present invention provides methods and systems for running a gadget application without using a network connection to a remote server. A method for running a gadget application without using a network connection includes receiving a gadget XML file associated with the gadget application on a local server. The method also includes parsing the gadget XML file and an associated message bundle according to a gadget specification. This is performed without a network connection. The method further includes rendering the gadget application. This is also performed without a network connection. The method also includes displaying the gadget application on a display coupled to the local server. A system for running a gadget application without using a network connection includes a gadget parser and a gadget renderer.

### FIELD OF THE INVENTION

The present invention relates to web based applications.

### BACKGROUND OF THE INVENTION

Miniature applications that offer dynamic content, such as GOOGLE Gadgets, can be developed by users, such as GOOGLE users, and placed on any page on the web, including home pages, personalized search pages such as iGoogle, or GOOGLE Desktop. Gadgets may be developed by GOOGLE users to provide calendars, news, weather, games, visual scenery, music or any other creative dynamic application. Gadgets may be shared with other GOOGLE users.

GOOGLE gadgets are developed using extensible markup language (XML). A Gadget XML file specifies instructions on how to process and render the gadget. The gadget XML file can contain all of the data and code for the gadget, including HTML and code such as JavaScript. Gadgets are run when made available to a remote server over the internet. Therefore, an internet connection has been required to effectively run or even test gadgets. However, due to different circumstances, such as traveling in an airplane, security issues or privacy concerns, an internet connection is not always available. Gadget development is stunted without a connection to a remote server that runs the gadget application.

### BRIEF SUMMARY

Embodiments of this invention relate to running a gadget application without using a network connection to a remote server. A method for running a gadget application without using a network connection includes receiving a gadget XML file associated with the gadget application on a local server. The method also includes parsing the gadget XML file according to a gadget specification. This is performed without a network connection. The method further includes rendering the gadget application in static HTML. This is also performed without a network connection. The method also includes displaying the gadget application on a display coupled to the local server.

A system for running a gadget application without using a network connection includes a gadget parser configured to receive a gadget XML file associated with the gadget application on a local server. The gadget parser is further configured to parse the gadget XML file according to a gadget specification. This is also performed without using a network connection. The system also includes a gadget renderer configured to render the gadget application in static HTML and display the gadget application on a display coupled to the local server.

Another method for running a gadget application without using a network connection receiving a markup language file associated with the web based application on a local server. The method also includes parsing the markup language file according to a web based markup language specification. This is performed without a network connection. The method further includes rendering the web based application without using a network connection to a remote server configured to handle markup language files according to the web based markup language specification. The method further includes displaying the web based application on a display coupled to the local server.

Further embodiments, features, and advantages of the invention, as well as the structure and operation of the various embodiments of the invention are described in detail below with reference to accompanying drawings.

### BRIEF DESCRIPTION OF THE FIGURES

Embodiments of the invention are described with reference to the accompanying drawings. In the drawings, like reference numbers may indicate identical or functionally similar elements. The drawing in which an element first appears is generally indicated by the left-most digit in the corresponding reference number.

FIG. 1 shows example miniature applications, such as gadgets, which relate to embodiments of the present invention.

FIG. 2 illustrates an architecture diagram of a system for running gadget applications without a network connection according to an embodiment of the present invention.

FIG. 3 is a flowchart illustrating a method for running gadget applications without a network connection according to an embodiment of the present invention.

### DETAILED DESCRIPTION OF THE INVENTION

While the present invention is described herein with reference to illustrative embodiments for particular applications, it should be understood that the invention is not limited thereto. Those skilled in the art with access to the teachings provided herein will recognize additional modifications, applications, and embodiments within the scope thereof and additional fields in which the invention would be of significant utility.

Miniature applications that offer dynamic content, such as GOOGLE Gadgets, can be developed by users, such as GOOGLE users, and placed on any page on the web. Gadgets may also be shared with other GOOGLE users. Gadgets are developed using a general purpose markup language, XML. A gadget XML file specifies instructions on how to process and render the gadget. The file also contains all of the data and code for the gadget.

Gadget XML files are parsed according to a gadget specification. Components of an XML gadget specification include a content section, a user preferences section and a gadget preferences section. The content section (<Content>) is the main section and specifies the type of gadget. It includes programming logic and HTML elements that determine the appearance of a gadget. The content section can include JavaScript, ADOBE Flash, MICROSOFT Silverlight, or any other code for providing active dynamic content. The content section may also include a link to external content. Universal resource locators (URLs) may indicate where to find the rest of the elements.

The user preferences section (<UserPrefs>) defines controls that allow users to specify settings for the gadget. The user preferences section describes the user input fields that are turned into user interface controls when the gadget runs. For example, a gadget XML file may include user preference code such as:

<UserPref name=“mycolor” display_name=“Color”
default_value=“Yellow”

datatype=“enum” >

<EnumValue value=“Red” />

</UserPref>

User preferences are stored persistently and may be accessed from the gadget using a user preferences JavaScript API.

The gadget preferences section (<ModulePrefs>) specifies characteristics of the gadget, such as title, author, preferred sizing, etc. An example gadget preferences section is provided here:

<Module> <ModulePrefs title=“Today's Network Traffic”

title_url=“http://www/~googleuser/gadgets/stats/” height=“200”
author=“Jane Smith”
author_email=“xxx@google.com”/> <Content ...> ... content
...

</Content> </Module>

An example gadget XML file for a simple gadget is provided below:

<?xml version=“1.0” encoding=“UTF-8” ?>
<Module>

<ModulePrefs title=“Go to Photo Album” height=“250”

scaling=“false” />

<Content type=“html”>
<![CDATA[

<div style=“text-align:center”><a

id=“Riggs” title=“My Photo Album” target=“_blank”

href=“http://picasaweb.google.com/doc.examples/MyAlbum”>
<img border=“0”alt=“Photo”
src=“http://doc.examples.googlepages.com/thispicture.jpg”
title=“ClickHere.”></a> </div>

]]>
</Content>

</Module>Defining User Preferences

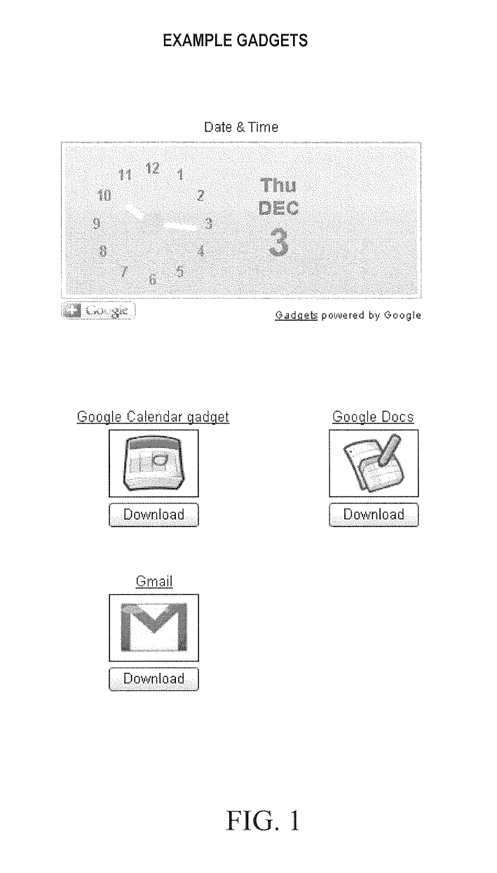

Gadgets are not private. Once a gadget is published on a public website, people can find it and view it. Gadgets may also be tested using Gadget Checker, which can help avoid common errors by catching problems with XML formatting and validity, HTML syntax, client-side latency, unused features, and missing elements. FIG. 1 shows an example gadget as well as other gadgets that may be downloaded.

Gadgets are run when they are made available to a remote server over the internet. Often, gadgets are uploaded to an hypertext transfer protocol (HTTP) server. For example, to preview a gadget's effects or to render a gadget through a GOOGLE Gadgets server or iGoogle server, a gadget developer will use server website addresses such as “www.google.cn/ig/adde?moduleur1=gadgets.xml” or “www.google.com/ig”. Therefore, an internet connection to a remote server is required to effectively run or even test gadgets. However, due to different circumstances, such as traveling in an airplane, security issues or privacy concerns, an internet connection is not always available. Gadget development is stunted without a connection to a remote server that runs the Gadget application.

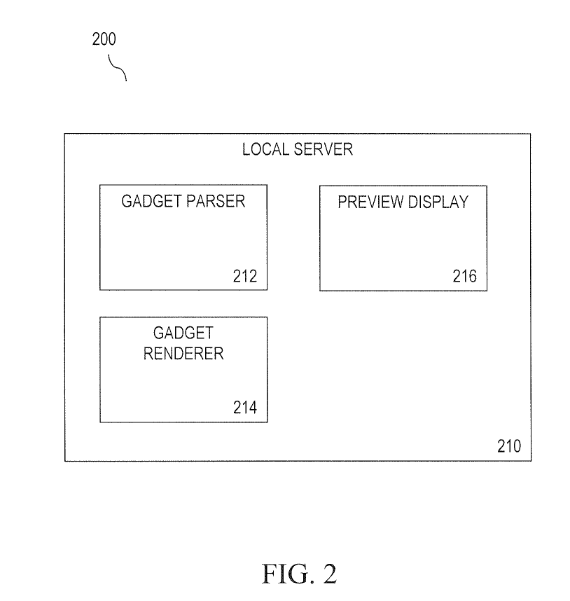

Embodiments of the present invention described below relate to running a gadget application without using a network connection, such as a connection to a remote gadget server. FIG. 2 is an architecture diagram of exemplary system 200 for running a gadget application without using a network connection according to an embodiment of the present invention. System 200 includes local server 210. Local server 210 may be an HTTP server established on a local device. A local device may be a computing device. Examples of computing devices include, but are not limited to, a computer, workstation, distributed computing system, computer cluster, embedded system, stand-alone electronic device, networked device, mobile device (e.g. mobile phone, smart phone or mobile computing device), rack server, set-top box, or other type of computer system having at least one processor and memory. Such a computing device may include software, firmware, hardware, or a combination thereof. Software may include one or more applications and an operating system. Hardware can include, but is not limited to, a processor, memory and graphical user interface display.

According to an embodiment, local server 210 may be configured to provide the functionality of a web server, which is a software component that responds to an HTTP request with an HTTP response. As illustrative examples, the web server may be, without limitation, an Apache HTTP Server, Apache Tomcat, MICROSOFT Internet Information Server, JBOSS Application Server, WEBLOGIC Application Server, or SUN JAVA System Web Server. A web server may contain web applications which generate content in response to an HTTP request. A web server may package the generated content and serve the content to a client in the form of an HTTP response. According to a further embodiment, a port may be specified on local server 210. For example, local server 210 may be defined as “localhost:7654”. Accordingly, a universal resource locator (URL) for rendering a gadget XML file may be established as “http://localhost:7654/render?moduleur1=abc.xml”.

According to an embodiment, local server 210 may include gadget parser 212, gadget renderer 214 and preview display 216. Gadget parser 212 may be configured to receive a gadget XML file associated with a gadget application on local server 210 without using a network connection. In most embodiments, local server 210 may be configured for using a network connection to a remote server, but the network connection may be unavailable at the relevant time. According to another embodiment, gadget parser 312 may be configured to establish local server 210 on a local device or other processor-based system. A local device may also be established as local server 210. Gadget parser 312 may be configured to specify a port associated with local server 210 to receive the gadget XML file.

Gadget parser 212 may be configured to retrieve a gadget XML file from a directory in the local server according to an embodiment. The directory may be static. According to a further embodiment, the retrieving and parsing may be performed automatically when the gadget XML file is saved in the directory. In some cases, a network connection to another directory may be utilized while a network connection to a remote server for running a gadget application according to a gadget specification may not be utilized. It is possible for a gadget developer to choose to preview a gadget application without connecting to a remote server, even though a network connection to the remote server is available or can be made available.

According to an embodiment, gadget parser 212 may be configured to parse a gadget XML file according to a gadget specification. A gadget specification and example code were described above. Gadget parser 212 may do so without using a network connection, or connecting to a remote server configured to handle the gadget XML file or run the gadget application. Gadget parser 212 may also be configured to parse an associated message bundle and/or use the associated message bundle to parse the gadget XML file and render the gadget application. A message bundle may be a template. A message bundle may also include keys and values. In most cases, a message bundle may be a separate XML file. According to some embodiments, preset gadget specifications and templates may be supported by local server 210.

According to a further embodiment, gadget parser 212 may be configured to parse a gadget XML file including a browser control component, which uses client language like C++, JAVA or C# depending on the corresponding operating system. According to most embodiments, gadget parser 212 may be configured to parse gadget XML files in order to run gadget applications in any known browser.

Local server 210 may include gadget renderer 214, according to an embodiment. Gadget renderer 214 may be configured to render the gadget application. In some cases, this may mean a conversion to or a rendering in static HTML. In other cases, some level of dynamic content may also be rendered by gadget renderer 214. According to most embodiments, gadget renderer 214 may be configured to render gadget applications in any known browser. According to a further embodiment, certain external information, perhaps data or code from an external link retrieved by gadget parser 212 or gadget renderer 214 at an early time, may be used to render the gadget application locally, without connection to a remote gadget server.

Gadget renderer 214 may be configured to display the gadget application on a display coupled to local server 210 according to an embodiment. For example, gadget renderer 214 may display a gadget application using preview display 216.

Each of gadget parser 212 and gadget renderer 214 may be implemented as software, hardware, firmware, or any combination thereof. According to some embodiments, system 200 may be configured to handle other markup language files or markup files that are specified according to other application specifications, standards or templates.

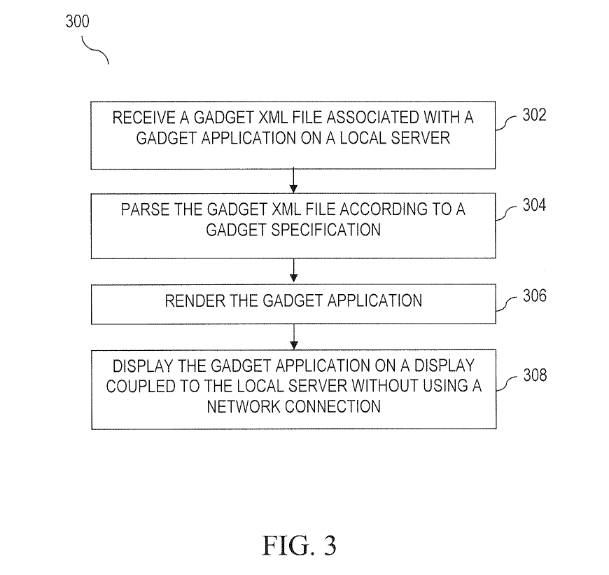

FIG. 3 is a flowchart of exemplary method 300 for running a gadget application without using a network connection. While method 300 is described with respect to an embodiment of the present invention, method 300 is not meant to be limiting and may be used in other applications. In an example, method 300 may be used to run a gadget application without the use of a network connection, like system 200 of FIG. 2. However, method 300 is not meant to be limited to system 200. As shown in FIG. 3, exemplary method 300 begins at stage 302 where a gadget XML file associated with a gadget application is received on a local server.

At stage 304, the gadget XML file is parsed according to a gadget specification. This is performed without using a network connection to a remote server or HTTP server configured to parse and render the gadget application according to a gadget specification. In some cases, an associated message bundle is also parsed or used to assist the parsing and rendering. It may also follow a gadget specification.

The gadget application is rendered at stage 306. In some cases, this includes a conversion to HTML for quick preview and display. Dynamic content can also be supported. Content from external links may be required. In such a case, external content can be retrieved at an earlier time before the network connection is disabled or not used. In some cases, substitute content may be provided for the external content. In other cases, modifications can be made to account for dynamic content or external links.

At stage 308, the gadget application is displayed. The gadget application may run on a display coupled to local server 210. This display may occur without a network connection.

Stages 302-308 may be implemented as software, hardware, firmware, or any combination thereof.

Embodiments of the invention provide many advantages. The integrated development environment (IDE) described above provides for preview of gadget applications without a network connection, or when a device or server is offline. As a result, a gadget application may be run or previewed without making the gadget XML file available to a remote server that handles gadget XML files. The offline gadgets IDE described above also provides for a quicker preview by the browser control.

The summary and abstract sections may set forth one or more but not all exemplary embodiments of the present invention as contemplated by the inventor(s), and thus, are not intended to limit the present invention and the appended claims in any way.

The present invention has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments.

I claim:

1. A computer-implemented method for running a gadget application without using a network connection comprising:
receiving a gadget XML file associated with the gadget application on a local server;
parsing the gadget XML file according to a gadget specification without using a network connection;
rendering the gadget application without using a network connection; and
displaying the gadget application on a display coupled to the local server.

2. The computer-implemented method of claim 1, further comprising:
establishing a local server on a processor-based system; and
specifying a port to receive the gadget XML file.

3. The computer-implemented method of claim 1, wherein the parsing includes parsing a gadget XML file having a browser control component.

4. The computer-implemented method of claim 1, further comprising:
retrieving the gadget XML file from a directory in the local server.

5. The computer-implemented method of claim 4, wherein the retrieving and parsing are performed automatically when the gadget XML file is saved in the directory.

6. The computer-implemented method of claim 1, wherein the rendering includes rendering the gadget application in static HTML.

7. A system for running a gadget application without using a network connection comprising:
a gadget parser configured to:
receive a gadget XML file associated with the gadget application on a local server; and
parse the gadget XML file according to a gadget specification without using a network connection; and
a gadget renderer configured to:
render the gadget application in static HTML; and
display the gadget application on a display coupled to the local server.

8. The system of claim 7, wherein the gadget parser is further configured to:
establish a local server on a processor-based system; and
specify a port to receive the gadget XML file.

9. The system of claim 7, wherein the gadget parser is further configured to parse a gadget XML file having a browser control component.

10. The system of claim 7, wherein the gadget parser is further configured to retrieve the gadget XML file from a directory in the local server.

11. The system of claim 10, wherein the gadget parser is further configured to automatically retrieve and parse the gadget XML file when the gadget XML file is saved in the directory.

12. A computer-implemented method for running a web based application without using a network connection comprising:
receiving a markup language file associated with the web based application on a local server;
parsing the markup language file according to a web based markup language specification without using a network connection;
rendering the web based application without using a network connection to a remote server configured to handle markup language files according to the web based markup language specification; and
displaying the web based application on a display coupled to the local server.
